(19) United States
(12) Patent Application Publication
(10) Pub. No.: US 2013/0135882 A1
(43) Pub. Date: May 30, 2013

(54) LIGHT EMITTING DIODE FOR AUTOMOTIVE LAMP

(71) Applicant: SAMSUNG ELECTRONICS CO., LTD., Suwon-si (KR)

(72) Inventor: Ki Won CHOI, Suwon-si (KR)

(73) Assignee: SAMSUNG ELECTRONICS CO., LTD., Suwon-si (KR)

(21) Appl. No.: 13/685,309

(22) Filed: Nov. 26, 2012

(30) Foreign Application Priority Data
Nov. 25, 2011 (KR) 10-2011-0124311

(51) Int. Cl. B60Q 1/26

(52) U.S. Cl. CPC B60Q 1/2696
USPC 362/487

(57) ABSTRACT

A light emitting diode (LED) module for an automotive lamp includes a plurality of supporting rods, a plurality of heat sinks, a circuit board and a plurality of LEDs. The supporting rods are connected to a bottom surface of a lamp housing having a predesigned shape. The heat sinks are respectively connected to an upper end of the supporting rods. The heat sinks are standardized to have at least one size. The circuit board is disposed on an upper surface of the plurality of heat sinks, to be bent according to an arrangement of the heat sinks. The LEDs are disposed on an area where the heat sinks are disposed, on the circuit board.

### CROSS-REFERENCE TO RELATED APPLICATION

This application claims benefit of priority to Korean Patent Application No. 10-2011-0124311, filed on Nov. 25, 2011, in the Korean Intellectual Property Office, the entire contents of which are hereby incorporated by reference.

### TECHNICAL FIELD

The present inventive concept relates to a light emitting diode (LED) module for an automotive lamp, and more particularly, to an LED module including a heat sink that may be suitably connected in the LED module for a design of an automotive lamp.

### BACKGROUND

Generally, an automotive lamp is disposed at a front or a rear of a car to emit different lights to the rear on different purposes by combining different lamps, colors and transparent patterns, and using a single lighting system including an indicator lamp, a stop lamp, a rear lamp, and the like. Using the automotive lamp, a car displays, to a pedestrian or another car positioned nearby, driving information, for example, a position of the car, a driving state, a direction of travel, and the like, thereby allowing the car being driven as well as other cars positioned nearby to be driven safely.

Since an automotive lamp has a great effect on an appearance of the car, in terms of a design of the car, it is important to alter a shape of the automotive lamp to provide various visual impressions. Accordingly, when a design of a particular model of a car is changed, various attempts are being made to create a design suitable for the changed design, in view of functional and esthetic aspects. Recently, a lamp using a light emitting diode (LED) as a light source is becoming increasingly popular.

A conventional automotive lamp has a structure in which an LED module, a reflecting structure, an internal lens, and an external lens are sequentially combined in a housing. As shown in FIG. 1, an LED module 10 may include a plurality of LEDs 11, a circuit board 12, a metallic plate 13, a heat sink 14, and a blanket 15. Although not shown in FIG. 1, the LED module 10 may further include a drive module configured to operate the plurality of LEDs 11.

The plurality of LEDs 11 may be mounted on the circuit board 12, and the circuit board 12 may be attached to the metallic plate 13. The metallic plate 13 may function as a heat emitting substrate, in conjunction with the heat sink 14. In particular, the heat sink 14 may perform a high heat emitting function in response to a high power operation of the LED module 10.

The blanket 15 may correspond to a plastic molding, and may support and fix the heat sink 14. The drive module may be electrically connected to the circuit board 12 to control an operation of the plurality of LEDs 11 based on a control signal and power transferred from an automobile control module (not separately shown).

Since the LED module 10 is configured to be mounted in an automotive lamp, the LED module 10 may have a stepped structure corresponding to a design of the automotive lamp. Accordingly, the elements included in the LED module 10, in particular, the metallic plate 13, the heat sink 14, and the blanket 15 may have stepped structures as well.

As aforementioned, a design of an automotive lamp may be changed when a design of a car model is changed. Accordingly, it would be desirable that the metallic plate 13, the heat sink 14, and the blanket 15 are newly designed and developed to be suitable for the changed design of the automotive lamp. However, a problem lies in a great amount of time and considerable cost expended, during such a new design and development process.

### SUMMARY

An aspect of the present inventive concept relates to a light emitting diode (LED) module for an automotive lamp, which may not need to be newly designed and developed when a design of the automotive lamp is changed, by connecting a heat sink, standardized to have at least one size, to an upper end of a supporting rod to be connected to a supporting plate or a lamp housing.

An aspect of the present inventive concept encompasses a light emitting diode (LED) module for an automotive lamp. The LED module may include a plurality of supporting rods connected to a bottom surface of a lamp housing having a predesigned shape, a plurality of heat sinks respectively connected to an upper end of the plurality of supporting rods, a circuit board disposed on an upper surface of the plurality of heat sinks, and a plurality of LEDs disposed on an area where the plurality of heat sinks is disposed, on the circuit board. The plurality of heat sinks may be standardized to have at least one size. The circuit board may be bent according to an arrangement of the plurality of heat sinks.

The plurality of supporting rods may have different heights, and may be connected to each other within the lamp housing, in order of height, to have a stepped arrangement.

The plurality of supporting rods may be standardized to have a single size.

The plurality of supporting rods may be connected onto a supporting plate mounted on the bottom surface of the lamp housing.

Each of the plurality of heat sinks may include a receiving recess, formed in a direction from a lower surface to an upper surface, to receive a corresponding one of the plurality of supporting rods.

Each of the plurality of heat sinks may include a first receiving recess formed in a direction from a lower surface to an upper surface, and a second receiving recess formed on a side wall of the first receiving recess. Each of the plurality of supporting rods may include a projection to be received in the second receiving recess of a corresponding one of the plurality of heat sinks when each supporting rod is received in the first receiving recess of the corresponding heat sink.

Each of the plurality of supporting rods may include a first receiving recess to receive a corresponding one of the plurality of heat sinks, and a projection formed on a side wall of the first receiving recess. Each of the plurality of heat sinks may include a second receiving recess, formed on an external side surface of each of the plurality of heat sinks, to receive the projection of a corresponding one of the plurality of supporting rods when each of the plurality of heat sinks is received in the first receiving recess of the corresponding supporting rod.

Each of the plurality of heat sinks may have a shape selected from one of a cylindrical shape, a polyprismatic shape, and an elliptic cylindrical shape.

The LED module may further include a drive module disposed on an external side surface of a supporting structure connected to an upper end of one of the plurality of supporting rods.

Another aspect of the present inventive concept encompasses a light emitting diode (LED) module for an automotive lamp. The LED module may include a plurality of supporting rods disposed on a bottom surface of a lamp housing having a predesigned shape, a plurality of heat sinks respectively disposed on an upper end of the plurality of supporting rods, a circuit board disposed on an upper surface of the plurality of heat sinks, and a plurality of LEDs disposed in an area where the plurality of heat sinks is disposed, on the circuit board. Each of the plurality of supporting rods may have a height selected from a plurality of standardized heights. Each of the plurality of heat sinks may have a size selected from a plurality of standardized sizes.

The circuit board may be bent according to an arrangement of the plurality of heat sinks.

The plurality of supporting rods may have different heights, and the plurality of supporting rods may be connected to each other within the lamp housing, in order of height, to have a stepped arrangement.

The plurality of supporting rods may have a single size.

The plurality of supporting rods may be connected onto a supporting plate disposed on the bottom surface of the lamp housing.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept. In the drawings, the thickness of layers and regions may be exaggerated for clarity.

FIG. 1 is an exploded perspective view illustrating a light emitting diode (LED) module for an automotive lamp according to a conventional art.

FIG. 2 is an exploded perspective view illustrating an LED module for an automotive lamp according to an embodiment of the present inventive concept.

FIGS. 3 and 4 are exploded perspective views illustrating an assembly structure of supporting rods according to various embodiments of the present inventive concept.

FIGS. 5 and 6 are perspective views illustrating a structure of a heat sink according to various embodiments of the present inventive concept.

FIGS. 7 to 9 are perspective views illustrating an assembly structure of a heat sink and a supporting rod according to various embodiments of the present inventive concept.

FIG. 10 is a perspective view illustrating a structure of a drive module according to an embodiment of the present inventive concept.

FIG. 11 is a perspective view illustrating an LED module for an automotive lamp including the drive module illustrated in FIG. 10.

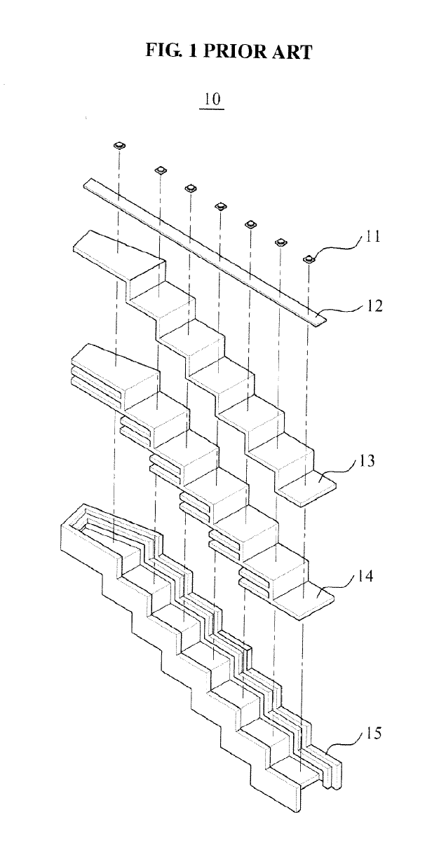

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

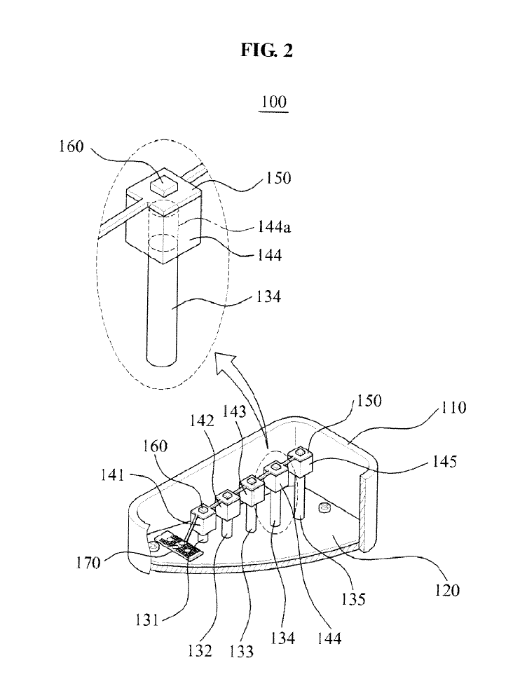

FIG. 2 is an exploded perspective view illustrating a light emitting diode (LED) module 100 for an automotive lamp according to an embodiment of the present inventive concept. Referring to FIG. 2, the LED module 100 may include a supporting plate 120, a plurality of supporting rods 131, 132, 133, 134, and 135, a plurality of heat sinks 141, 142, 143, 144, and 145, a circuit board 150, a plurality of LEDs 160, and a drive module 170. The foregoing elements may be included in a lamp housing 110 used for the automotive lamp.

The lamp housing 110 may have a predesigned shape corresponding to an exterior of an automotive lamp. A design of the lamp housing 110 is not limited to the shape illustrated in FIG. 2, and may be changed each time the automotive lamp is changed.

The supporting plate 120 may have a shape corresponding to a bottom surface of the lamp housing 110, and may be mounted on the bottom surface of the lamp housing 110. Also, the supporting plate 120 may include a plurality of connection recesses (not separately shown). Lower ends of the plurality of supporting rods 131 through 135 may be inserted in the plurality of connection recesses, respectively.

The plurality of supporting rods 131 through 135 may be installed on the supporting plate 120. The plurality of supporting rods 131 through 135 may have different heights, and may be connected to each other within the lamp housing 110, in order of height, to have a stepped arrangement.

The plurality of heat sinks 141 through 145 may be connected to an upper end of the plurality of supporting rods 131 through 135, respectively. In particular, as illustrated in FIG. 2, when a first heat sink 141, a second heat sink 142, a third heat sink 143, a fourth heat sink 144, a fifth heat sink 145, a first supporting rod 131, a second supporting rod 132, a third supporting rod 133, a fourth supporting rod 134, and a fifth supporting rod 135 are included in the LED module 100, the first heat sink 141 may be connected to the first supporting rod 131, the second heat sink 142 may be connected to the second supporting rod 132, the third heat sink 143 may be connected to the third supporting rod 133, the fourth heat sink 144 may be connected to the fourth supporting rod 134, and the fifth heat sink 145 may be connected to the fifth supporting rod 135.

The first through fifth heat sinks 141 through 145 may be provided in a shape selected from one of a cylindrical shape, a polyprismatic shape, and an elliptic cylindrical shape. Also, the first through fifth heat sinks 141 through 145 may be standardized to have at least one size. For example, when the first through fifth heat sinks 141 through 145 have a shape of a square pillar, the first through fifth heat sinks 141 through 145 may be standardized to have a size corresponding to a predetermined “width,” “length,” and “height.”

The first through fifth heat sinks 141 through 145 may have an identical size, or may have different sizes. The first through fifth heat sinks 141 through 145 may have several sizes depending on an amount of heat emitted, a size of the plurality of LEDs 160 included in the LED module 110, requirements of the automotive lamp on, for example, an exterior shape, and a size of the lamp, and the like.

For example, the first through fifth heat sinks 141 through 145 may have a first standardized size set to “width 1,” “length 1,” and “height 1,” a second standardized size set to “width 2,” “length 2,” and “height 2,” a third standardized size set to “width 3,” “length 3,” and “height 3,” and the like. Also, the first through fifth heat sinks 141 through 145 may have more varied sizes. Accordingly, when the design of the automotive lamp is changed, heat sinks having a size corresponding a size of the automotive lamp may be connected. That is, when the design of the automotive lamp is changed, heat sinks having a size suitable for a changed design of the automotive lamp may be connected to supporting rods, without new heat sinks being designed and developed.

The first through fifth heat sinks 141 through 145 may include respective receiving recesses formed in a direction from a lower surface to an upper surface. Referring to a partially enlarged view in FIG. 2, the fourth heat sink 144 may include a receiving recess 144a, in which the fourth supporting rod 134 may be received. In this instance, the fourth supporting rod 134 may be received to a depth corresponding to a height of the recess 144a.

As aforementioned, the receiving recesses may be provided for connecting the first through fifth heat sinks 141 through 145 to the first through fifth supporting rods 131 through 135. Accordingly, the receiving recesses may have a shape and size corresponding to a shape and size of the first through fifth supporting rods 131 through 135.

In an embodiment of the present inventive concept, the first through fifth supporting rods 131 through 135 may be standardized to have varied sizes. However, the first through fifth supporting rods 131 through 135 may be different in height only, and may be standardized to have a single shape and a single breadth (for example, a width, a length, or a radius, and the like). That is, the first through fifth supporting rods 131 through 135 may have different standardized heights. When the first through fifth supporting rods 131 through 135 are standardized to have the single breadth and shape, the respective receiving recesses included in the first through fifth heat sinks 141 through 145 may also be standardized to have a single size and shape. Accordingly, when the design of the automotive lamp is changed, supporting rods having heights suitable for the changed design of the automotive lamp may be applied, without the need to design and develop new supporting rods.

The circuit board 150 may be disposed on an upper surface of the first through fifth heat sinks 141 through 145, to electrically connect all or portions of the first through fifth heat sinks 141 through 145.

The circuit board 150 may correspond to a flexible printed circuit board (FPCB), and may be bent depending on an arrangement of the first through fifth heat sinks 141 through 145.

The plurality of LEDs 160 may be mounted in an area where the first through fifth heat sinks 141 through 145 may be disposed, on the circuit board 150. In this instance, each or at least two of the plurality of LEDs 160 may be mounted on the circuit board 150 of the area where the first through fifth heat sinks 141 through 145 may be disposed.

The LED module 100 shown in FIG. 2 may be suitably disposed for the design of the lamp housing 110, by connecting the standardized first through fifth supporting rods 131 through 135 and the standardized first through fifth heat sinks 141 through 145, respectively.

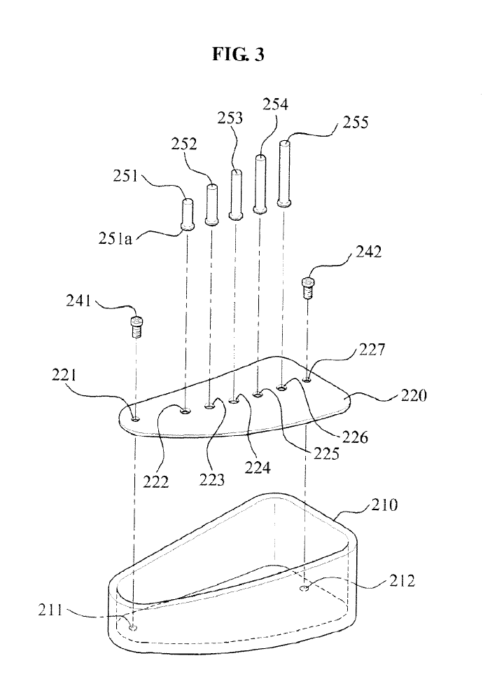

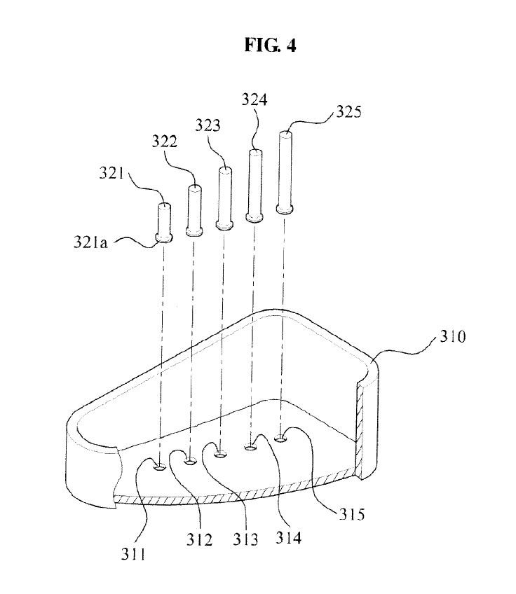

FIGS. 3 and 4 are exploded perspective views illustrating an assembly structure of supporting rods according to various embodiments of the present inventive concept.

In FIG. 3, a first supporting rod 251, a second supporting rod 252, a third supporting rod 253, a fourth supporting rod 254, and a fifth supporting rod 255 may be connected to a supporting plate 220 to be disposed in a lamp housing 210.

The lamp housing 210 may be a case in which elements used for the automotive lamp may be included. For example, an LED module may be included in the lamp housing 210.

The lamp housing 210 may include a first screw recess 211 and a second screw recess 212 to fix the supporting plate 220.

The supporting plate 220 may have a shape corresponding to a shape of a bottom surface of the lamp housing 210. Accordingly, the shape of the supporting plate 220 may be changed depending on a design of the lamp housing 210.

The supporting plate 220 may include a first screw hole 221, a second screw hole 227, a first connection recess 222, a second connection recess 223, a third connection recess 224, a fourth connection recess 225, and a fifth connection recess 226.

The first screw hole 221 and the second screw hole 227 may be included at positions corresponding to positions of the two screw recesses 221 and 212, when the supporting plate 220 is mounted on the bottom surface of the lamp housing 210.

The supporting plate 220 may be fixed on the lamp housing 210 by fastening screws 241 and 242 to the first screw hole 221 and the second screw hole 227, respectively, and to the first screw recess 221 and the second screw recess, respectively, while mounted on the bottom surface of the lamp housing 210.

The first through fifth supporting rods 251 through 255 may be inserted in the first through fifth connection recesses 222 through 226, respectively. The first supporting rod 251 may include a connection protrusion 251a at a lower end of the first supporting rod 251. Also, the second through fifth supporting rods 252 through 255 may include respective connection protrusions as well. When each connection protrusion is inserted in a corresponding one of the first through fifth connection recesses 222 through 226, the first through fifth supporting rods 252 through 255 may be connected to the supporting plate 220.

In the embodiment illustrated in FIG. 3, the supporting plate 220 includes five connection recesses 222 through 226, which are arranged at regular intervals, however, it is not limited thereto. An arrangement and a number of connection recesses may be changed depending on a design of the lamp housing 210.

In the embodiment illustrated in FIG. 3, the first through fifth supporting rods 251 through 255 may only have different heights, and may be standardized to have a single breadth, a single shape, and the like. That is, as shown in FIG. 3, the first through fifth supporting rods 251 through 255 may only differ in height. The first through fifth supporting rods 251 through 255 may have a cylindrical shape with an identical radius, and may be inserted in the first through fifth connection recesses 222 through 226 in order of height, respectively. Accordingly, by inserting the standardized first through fifth supporting rods 251 through 255 in the first through fifth connection recesses 222 through 226 included in the supporting plate 220, respectively, the first through fifth supporting rods 251 through 255 may be suitably disposed for the design of the lamp housing 210.

Referring to FIG. 4, a first supporting rod 321, a second supporting rod 322, a third supporting rod 323, a fourth supporting rod 324, and a fifth supporting rod 325 may be connected on a bottom surface of a lamp housing 310 directly, instead of connecting to a supporting plate.

The lamp housing 310 may include a first connection recess 311, a second connection recess 312, a third connection recess 313, a fourth connection recess 314, and a fifth connection recess 315 to fix the first through fifth supporting rods 321 through 325, respectively.

The first through fifth supporting rods 321 through 325 may be inserted in the first through fifth connection recesses 311 through 315, respectively. The first supporting rod 321 may include a connection protrusion 321a at a lower end of the supporting rod 321. Also, the second through fifth supporting rods 312 through 315 may include respective connection protrusions as well.

When each connection protrusion is inserted in a corresponding one of the first through fifth connection recesses 311 through 315, the first through fifth supporting rods 321 through 325 may be connected to the lamp housing 310.

An arrangement and a number of connection recesses may be changed depending on a design of the lamp housing 310. For example, when the design of the lamp housing 310 is changed, a required number of connection recesses may be formed at positions at which supporting rods are desired to be disposed, in a process of manufacturing a lamp housing.

In the embodiment illustrated in FIG. 4, by inserting the first through fifth supporting rods 321 through 325 in the first through fifth connection recesses 311 through 315 included in the lamp housing 310, the first through fifth supporting rods 321 through 325 may be suitably disposed for the design of the lamp housing 310.

In the embodiment illustrated in FIG. 4, by connecting the first through fifth supporting rods 321 through 325 to the lamp housing 310 directly, without a separate supporting plate, a cost for the supporting plate may be reduced, and a connection process may be more simplified.

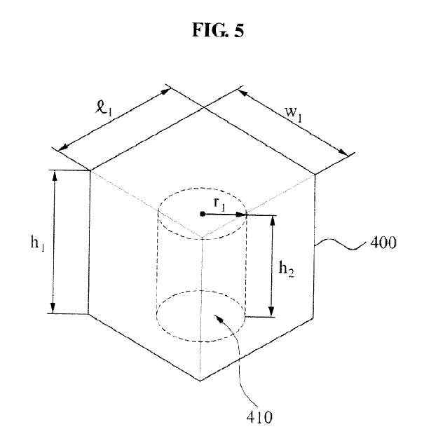

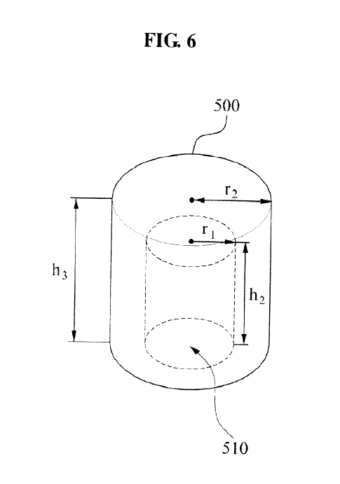

FIGS. 5 and 6 are perspective views illustrating a structure of a heat sink according to various embodiments of the present inventive concept. A heat sink provided in embodiments of the present inventive concept may be an element to be connected to an upper end of the first through fifth supporting rods 251 through 255 illustrated in FIG. 3, or the first through fifth supporting rods 321 through 325 illustrated in FIG. 4, and may be standardized to have at least one size.

The heat sink may have a shape of a square pillar as illustrated in FIG. 5, or may have a cylindrical shape as illustrated in FIG. 6.

Referring to FIG. 5, a heat sink 400 may be standardized to have a “width 1 w₁,” a “length 1 l₁,” and a “height 1 h₁.” The heat sink 400 may include a receiving recess 410 formed in a direction from a lower surface to an upper surface. An upper end of a supporting rod may be received in the receiving recess 410 up to a depth corresponding to a predetermined height.

According to embodiments of the present inventive concept, a supporting rod may be standardized to have a single breadth, for example, a width, a length, or a radius, excluding a height. Accordingly, the receiving recess 410 may also be standardized to have a single size corresponding to the breadth of the supporting rod, for example, the width, the length, or the radius.

When a supporting rod has a cylindrical shape, and is standardized to have a “radius 1 r₁,” the receiving recess 410 may also have a cylindrical shape, and may be standardized to have a size corresponding to the “radius 1 r₁.” Also, the receiving recess 410 may be standardized to have a “height 2 h₂” in order to receive the supporting rod to a depth corresponding to a predetermined height.

Referring to FIG. 6, a heat sink 500 may be standardized to have a “radius 2 r₂” and a “height 3 h₃.” The heat sink 500 also may include a receiving recess 510. The receiving recess 510 may be standardized to have a “radius 1 r₁” and a “height 2 h₂” that may be identical to the “radius 1 r₁” and the “height 2 h₂” of the receiving recess 410 illustrated in FIG. 5.

As aforementioned, since the supporting rod may be standardized to have a single breadth, for example, a width, a length, or a radius, excluding a height, the receiving recess 510 may be standardized to have a single size corresponding to the breadth of the supporting rod, for example, the width, the length, or the radius.

Since the heat sink 400 of FIG. 5 and the heat sink 500 of FIG. 6 may include the receiving recess 410 and the receiving recess 510 having standardized shapes and sizes, respectively, one of the heat sink 400 and the heat sink 500 may be used selectively depending on a design of a lamp housing.

Although only the heat sink 400 and the heat sink 500 that may be standardized to have two sizes are illustrated in FIGS. 5 and 6 and described with reference to FIGS. 5 and 6, the heat sink 400 and the heat sink 500 may be standardized to have varied sizes. Accordingly, heat sinks of various standardized sizes may be suitably connected to a supporting rod for a lamp design, and a new heat sink may not need to be redesigned and redeveloped to suit a new lamp to design.

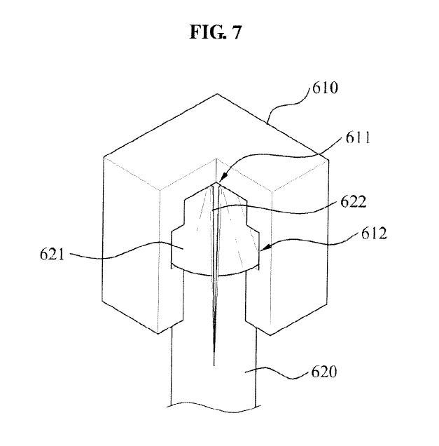

FIGS. 7 to 9 are perspective views illustrating an assembly structure of a heat sink and a supporting rod according to various embodiments of the present inventive concept.

Each of the heat sink 400 of FIG. 5 and the heat sink 500 of FIG. 6 may include a single receiving recess formed in a direction from a lower surface to an upper surface. However, each of the heat sink 400 and the heat sink 500 may further include another receiving recess so that each of the heat sink 400 and the heat sink 500 may be fixed to a supporting rod. This will be described in detail with reference to FIGS. 7 through 9.

Referring to FIG. 7, a heat sink 610 may include a first receiving recess 611 formed in a direction from a lower surface to an upper surface, and a second receiving recess 612 formed on a side wall of the first receiving recess 611. The second receiving recess 612 may be formed on all over four side walls of the first receiving recess 611.

A supporting rod 620 may be received in the first receiving recess 611 of the heat sink 610. As illustrated in FIG. 7, the supporting rod 620 may include a projection 621 of a conical shape that may be received in the second receiving recess 612 while being received in the first receiving recess 611. When the projection 621 is received in the second receiving recess 612, the heat sink 610 and the supporting rod 620 may be engaged with each other, and may not be separated from each other.

The supporting rod 620 may include a vertical incision 622 in order to prevent the projection 621 from being stuck at an entrance of the first receiving recess 611, in a process in which the supporting rod 620 may be received in the first receiving recess 611 of the heat sink 610. The vertical incision 622 may allow the projection 621 to be pressed and gather so that the supporting rod 620 may be received into the first receiving recess 611 easily.

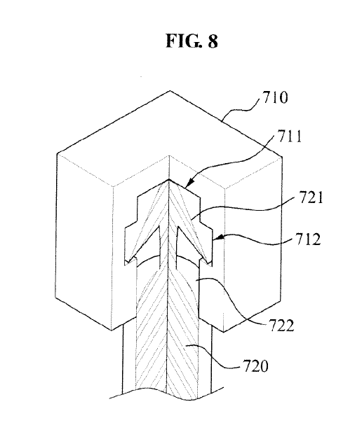

Referring to FIG. 8, a heat sink 710 may include a first receiving recess 711 formed in a direction from a lower surface to an upper surface, and a second receiving recess 712 formed on a side wall of the first receiving recess 711.

A supporting rod 720 may be received in the first receiving recess 711 of the heat sink 710. As illustrated in FIG. 8, the supporting rod 720 may include a projection 721 of an arrow shape that may be received in the second receiving recess 712 while being received in the first receiving recess 711. When the projection 721 is received in the second receiving recess 712, the heat sink 710 and the supporting rod 720 may be engaged with each other, and may not be separated from each other.

In a process in which the supporting rod 720 may be received in the first receiving recess 711 of the heat sink 710, a lower end portion of the arrowhead of the projection 721 may be pressed so that the supporting rod 720 may be received in the first receiving recess 711, easily.

The supporting rod 720 may include a supporting portion 722 that may be stuck at an entrance of the first receiving recess 711. The supporting portion 722 may prevent the supporting rod 720, received in the first receiving recess 711, from moving, and may support the heat sink 710.

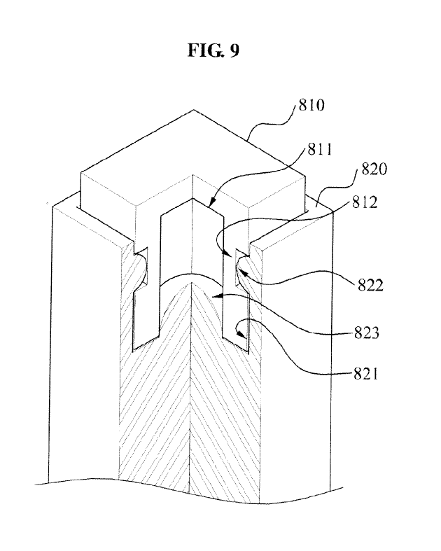

According to the embodiment illustrated in FIG. 9, a heat sink 810 may have an assembly structure in which the heat sink 810 may be received in a supporting rod 820, in manner different from the heat sink 610 of FIG. 7 and the heat sink 710 of FIG. 8.

Referring to FIG. 9, the supporting rod 820 may include a first receiving recess 821 to receive the heat sink 810, and a projection 822 formed on a side surface of the first receiving recess 821. The projection 822 may be fainted over all four side walls of the first receiving recess 821.

The heat sink 810 may be received in the first receiving recess 821 of the supporting rod 820.

The heat sink 810 may include an empty space 811 on the inside of the heat sink 810. Also, the heat sink 810 may include a second receiving recess 812, e.g., on outer surfaces of the heat sink 810, to receive the projection 822 while being received in the first receiving recess 821.

The supporting rod 820 may include a supporting portion 823 that may be inserted in the empty space 811 of the heat sink 810. The supporting portion 823 may support the heat sink 810 that may be received in the first receiving recess 821.

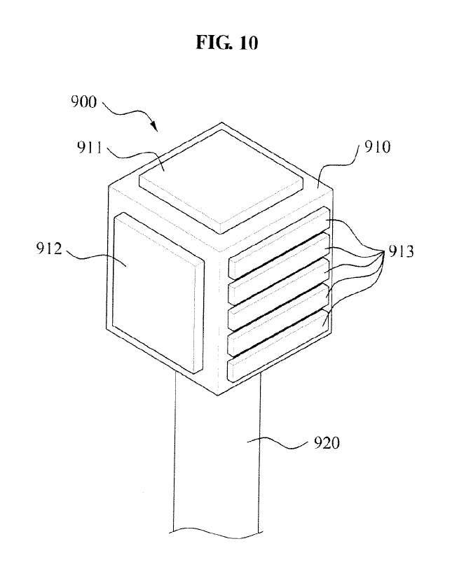

FIG. 10 is a perspective view illustrating a structure of a drive module 900 according to an embodiment of the present inventive concept.

The drive module 900 may include a control portion 911, a power resource portion 912, and a circuit portion 913 that may be disposed on external side surfaces of a supporting structure 910.

The supporting structure 910 may have a structure identical to the structure of the first through fifth heat sinks 141 through 145 illustrated in FIG. 2. In particular, the supporting structure 910 may have a shape of a square pillar, and may include a receiving recess through which the supporting structure 910 may be connected to a supporting rod 920. That is, the supporting structure 910 may have a shape identical to the shape of the first through fifth heat sinks 141 through 145, and may have a structure in which the drive module 900 may be connected to the supporting rod 920.

Also, the supporting structure 910 may be standardized to have at least one size. Accordingly, a drive module may be configured by selecting a supporting structure having an appropriate size depending on a change in design of an automotive lamp.

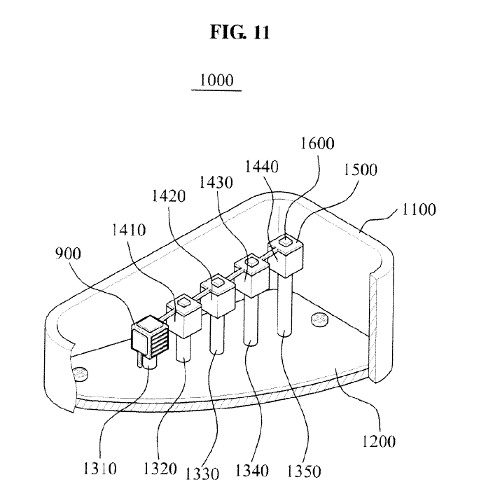

FIG. 11 is a perspective view illustrating an LED module 1000 for an automotive lamp including the drive module 900 illustrated in FIG. 10.

Referring to FIG. 11, the LED module 1000 may include a supporting plate 1200, a first supporting rod 1310, a second supporting rod 1320, a third supporting rod 1330, a fourth supporting rod 1340, a fifth supporting rod 1350, the drive module 900, a first heat sink 1410, a second heat sink 1420, a third heat sink 1430, a fourth heat sink 1440, a circuit board 1500, and a plurality of LEDs 1600. The foregoing elements may be included in a lamp housing 1100 used for the automotive lamp.

The elements, excluding the drive module 900 from the LED module 1000 of FIG. 11, is identical to or similar to the elements included in the LED module 100 of FIG. 2 and thus, duplicated descriptions will be omitted for conciseness.

The drive module 900 is illustrated in FIG. 10. The drive module 900 and the first through fourth heat sinks 1410 through 1440 may be connected to an upper end of the first through fifth supporting rods 1310 through 1350. Accordingly, a space necessary for installing the drive module 900 in the lamp housing may be reduced, and the installation may be easy.

According to embodiments of the present inventive concept, an LED module for an automotive lamp may have a structure in which a heat sink, standardized to have at least one size, may be connected to an upper end of a supporting rod and further connected to a supporting plate or a lamp housing. Accordingly, when a design of the automotive lamp is changed, the heat sink and the supporting rod may be suitably connected for the changed design, thereby reducing a cost and an amount of time expended in designing or developing a new heat sink or supporting rod.

Although a few exemplary embodiments of the present inventive concept have been shown and described, the present inventive concept is not limited to the described exemplary embodiments. Instead, it would be appreciated by those skilled in the art that changes may be made to these exemplary embodiments without departing from the principles and spirit of the inventive concept, the scope of which is defined by the appended claims and their equivalents.

What is claimed is:

1. A light emitting diode (LED) module for an automotive lamp, the LED module comprising:
a plurality of supporting rods connected to a bottom surface of a lamp housing having a predesigned shape;
a plurality of heat sinks respectively connected to an upper end of the plurality of supporting rods, the plurality of heat sinks being standardized to have at least one size;
a circuit board, disposed on an upper surface of the plurality of heat sinks, to be bent according to an arrangement of the plurality of heat sinks; and
a plurality of LEDs disposed in an area where the plurality of heat sinks is disposed, on the circuit board.

2. The LED module of claim 1, wherein:
the plurality of supporting rods has different heights, and
the plurality of supporting rods is connected to each other within the lamp housing, in order of height, to have a stepped arrangement.

3. The LED module of claim 1, wherein the plurality of supporting rods is standardized to have a single size.

4. The LED module of claim 1, wherein the plurality of supporting rods is connected onto a supporting plate disposed on the bottom surface of the lamp housing.

5. The LED module of claim 1, wherein each of the plurality of heat sinks comprises a receiving recess, formed in a direction from a lower surface to an upper surface, to receive a corresponding one of the plurality of supporting rods.

6. The LED module of claim 1, wherein each of the plurality of heat sinks comprises:
a first receiving recess formed in a direction from a lower surface to an upper surface; and
a second receiving recess formed on a side wall of the first recess.

7. The LED module of claim 6, wherein each of the plurality of supporting rods comprises a projection to be received in the second receiving recess of a corresponding one of the plurality of heat sinks when each supporting rod is received in the first receiving recess of the corresponding heat sink.

8. The LED module of claim 1, wherein each of the plurality of supporting rods comprises:
a first receiving recess to receive a corresponding one of the plurality of heat sinks; and
a projection formed on a side wall of the first receiving recess.

9. The LED module of claim 8, each of the plurality of heat sinks comprises:
a second receiving recess, formed on an external side surface of each of the plurality of heat sinks, to receive the projection of a corresponding one of the plurality of supporting rods when each of the plurality of heat sinks is received in the first receiving recess of the corresponding supporting rod.

10. The LED module of claim 1, wherein each of the plurality of heat sinks has a shape selected from one of a cylindrical shape, a polyprismatic shape, and an elliptic cylindrical shape.

11. The LED module of claim 1, further comprising:
a drive module disposed on an external side surface of a supporting structure connected to an upper end of one of the plurality of supporting rods.

12. A light emitting diode (LED) module for an automotive lamp, the LED module comprising:
a plurality of supporting rods disposed on a bottom surface of a lamp housing having a predesigned shape, each of the plurality of supporting rods having a height selected from a plurality of standardized heights;
a plurality of heat sinks respectively disposed on an upper end of the plurality of supporting rods, each of the plurality of heat sinks having a size selected from a plurality of standardized sizes;
a circuit board disposed on an upper surface of the plurality of heat sinks; and
a plurality of LEDs disposed in an area where the plurality of heat sinks is disposed, on the circuit board.

13. The LED module of claim 12, wherein the circuit board is bent according to an arrangement of the plurality of heat sinks.

14. The LED module of claim 12, wherein:
the plurality of supporting rods has different heights, and
the plurality of supporting rods is connected to each other within the lamp housing, in order of height, to have a stepped arrangement.

15. The LED module of claim 12, wherein the plurality of supporting rods has a single size.

16. The LED module of claim 12, wherein the plurality of supporting rods is is connected onto a supporting plate disposed on the bottom surface of the lamp housing.
